(19) United States
(12) Patent Application Publication
(10) Pub. No.: US 2010/0047656 A1
(43) Pub. Date: Feb. 25, 2010

(54) Dense Gd-doped Ceria Layers on Porous Substrates and Methods of Making the Same

(76) Inventors: Xiaohong S Li, Richland, WA (US); Prabhakar Singh, Richland, WA (US); Xiao-Dong Zhou, Richland, WA (US)

Correspondence Address: BATTELLE MEMORIAL INSTITUTE;ATTN: IP SERVICES, K1-53, P. O. BOX 999, RICHLAND, WA, 99352, US

(21) Appl. No.: 12/194,326

(22) Filed: Aug. 19, 2008

(51) Int. Cl. H01M 8/10; B05D 5/12

(52) U.S. Cl. 429/33; 427/115

(57) ABSTRACT

Solid-state ionic or electrochemical devices can depend critically on the proper formation of a dense, Gd-doped ceria (GDC) layer on a porous substrate. Devices and methods of the present invention are characterized by the formation of a transitional buffer layer, which is less than 10 microns thick and comprises GDC, located between the porous substrate and the dense GDC layer. The transitional buffer layer provides a practical way to form the dense GDC layer on the porous substrate without cracks in the GDC layer and without clogging the pores of the substrate.

### STATEMENT REGARDING FEDERALLY SPONSORED RESEARCH OR DEVELOPMENT

This invention was made with United States Government support under Contract NNC06CA45C awarded by National Aeronautics and Space Administration (NASA). The Government has certain rights in the invention.

### BACKGROUND

When fabricating high performance solid-state ionic devices or electrochemical systems, which can include solid oxide fuel cells (SOFCs), gas sensors, membrane reactors for gas separation or electrosynthesis, and reformers for the processing of hydrocarbon fuels, the preparation of dense ceramic membranes on porous electrodes or substrates can be the most critical step. In each of these applications, thin ceramic membranes must be supported by porous substrates since the electroactive species and the reaction products must transport to or away from the surfaces of the dense ceramic membrane.

Thin dense GdₓCe₁₋ₓO₂ (GDC) films are of particular interest because of their high oxygen ion conductivity and their performance in devices operating at intermediate temperatures such as those less than 600 degrees Celsius. However, the implementation of GDC films in solid-state ionic devices and/or electrochemical systems has been limited, in part, by the challenges associated with forming thin dense GDC films on porous substrates having relatively large pore sizes. Specifically, it can be difficult to prevent cracking and/or seepage of material into the pores of the substrate while obtaining the required densities and thicknesses. Furthermore, many of the available techniques for preparing dense ceramic layers on porous substrates can be expensive and complex. Accordingly, a need exists for dense GDC layers on porous substrates, as well as methods for producing such dense layers.

### SUMMARY

Embodiments of the present invention include solid-state ionic or electrochemical devices having a dense GDC layer on a porous substrate, as well as methods for fabricating the dense GDC layer. The devices are characterized by a transitional buffer layer that is less than 10 microns thick, comprises GDC, and is located between the porous substrate and the dense GDC layer. The transitional buffer layer provides a practical way to form the dense GDC layer on the porous substrate without cracks in the GDC layer and without clogging the pores of the substrate.

In some embodiments, the transitional buffer layer comprises GDC particles having a primarily bimodal distribution of particle sizes. Ideally, the transitional buffer layer would be as thin as possible. Accordingly, in a preferred embodiment the transitional layer buffer thickness is between approximately two and approximately five microns.

For some device applications, the substrate needs to be very porous and to have large pores. More specifically, the porous substrate can have a porosity greater than approximately forty percent. Furthermore, the pores can have a diameter of at least approximately five microns. In the example of solid oxide fuel cell devices, such high porosity and large pore sizes facilitate gas diffusion and fuel utilization associated with a porous anode and dense electrolyte.

In a preferred embodiment the porous substrate comprises a metal or a cermet. Having a metal or a cermet substrate can complicate the fabrication of the dense GDC layer and can introduce additional challenges relative to other substrates such as ceramics. For example, when the solid-state ionic or electrochemical device includes a porous metal substrate on which the dense GDC layer is deposited, the differences in coefficients of thermal expansion between the metal substrate and the dense GDC layer can cause cracking during heat treatment. Accordingly, the role of the transitional buffer layer becomes even more critical. In some embodiments the metal substrate surface is oxidized to better match the coefficient of thermal expansion of GDC and/or the transitional buffer layer. The transitional buffer layer can then be formed on the oxidized surface. The dense GDC layer is then formed over the transitional buffer layer. In preferred embodiments, the dense GDC layer is less than or equal to approximately five microns thick. The particular thickness of the dense GDC layer, and/or the transitional buffer layer, can be controlled by depositing multiple layers in order to build up to the desired thickness.

Embodiments of the present invention also include methods for fabricating the dense GDC layer on the porous substrate. The methods comprise depositing a high viscosity GDC (HV-GDC) slurry on the porous substrate and sintering the HV-GDC slurry at a temperature below a thousand degrees. The HV-GDC slurry has viscosity greater than 4,000 cP and after sintering forms a transitional buffer layer that is less than 10 microns thick. The method then comprises forming a dense GDC layer on the transitional buffer layer. The method can further comprise infiltrating the transitional buffer layer and/or the dense GDC layer with a slurry containing relatively finer GDC particles compared to the slurries used for the transitional buffer layer and/or the dense GDC layer.

In preferred embodiments the HV-GDC slurry is deposited by screen printing or tape casting. In some instances the substrate is very porous and contains large pores. For these types of substrates, multiple coatings can be applied to compose the transitional buffer layer. In one example, deposition and sintering of the HV-GDC slurry can be followed by deposition of a lower-viscosity GDC (LV-GDC) slurry and sintering the LV-GDC slurry at a temperature below 1,000 degrees Celsius. The LV-GDC has a viscosity less than 4,000 cP. The transitional buffer layer comprises both the HV-GDC deposit and the LV-GDC deposit and has a total thickness less than 10 microns. In another embodiment the transitional buffer layer can comprise alternating layers of HV-GDC and LV-GDC deposits, wherein each deposit is sintered at a temperature below 1,000 degrees Celsius and the total thickness of the alternating deposits is less than 10 microns thick. In preferred embodiments the LV-GDC slurry is applied by spin coating and, as described elsewhere herein, the HV-GDC deposit is applied by screen printing or tape casting.

In some embodiments the HV-GDC slurry can comprise primarily a bimodal distribution of GDC particle sizes. For example, an HV-GDC slurry can predominately comprise particles having diameters of approximately 250 nanometers and particles having diameters of approximately 5 to 10 nanometers.

In preferred embodiments the porous substrate comprises a metal or a cermet. In such embodiments, methods of the present invention can further comprise oxidizing the metal substrate surface to minimize differences in the coefficients of thermal expansion between the GDC and the metal substrate.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is a block diagram depicting an exemplary process for forming dense GDC layers on a porous substrate according to embodiments described herein.

FIG. 2 is a micrograph showing the surface morphology of a porous substrate on which a dense GDC layer can be formed according to embodiments of the present invention.

FIG. 3 contains two micrographs showing at two different magnification levels the surface morphology of a transitional buffer layer formed on a porous substrate using embodiments of the present invention.

FIG. 4 is a micrograph showing a cross-sectional view of a dense GDC layer formed on a porous substrate with a transitional buffer layer according to embodiments of the present invention.

### DETAILED DESCRIPTION

The following description includes the preferred best mode of one embodiment of the present invention. It will be clear from this description of the invention that the invention is not limited to these illustrated embodiments, but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

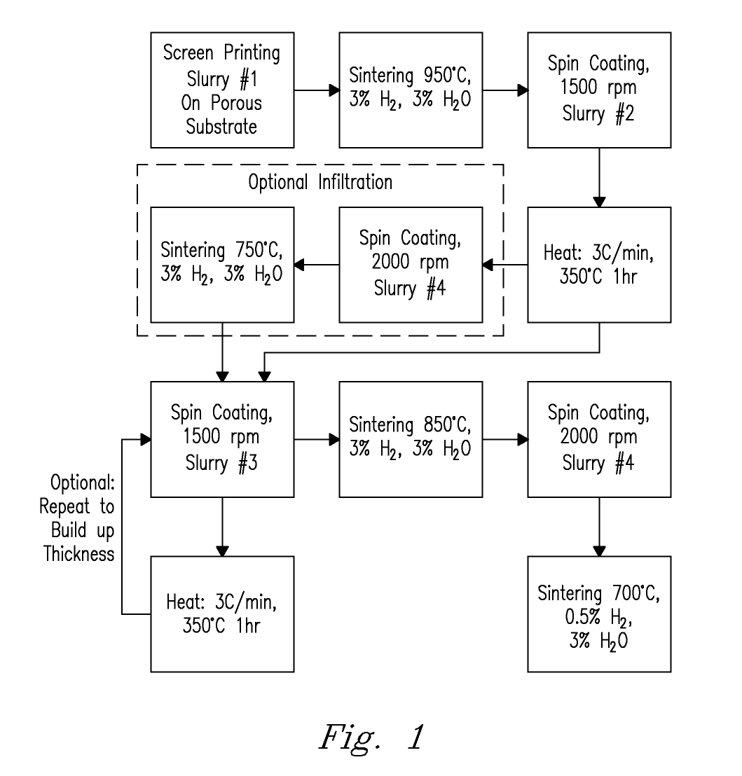

Referring first to FIG. 1, a block diagram illustrates the procedure for forming a particular example of a dense GDC layer on a porous substrate. While the procedure details the formation of multiple GDC layers, as well as specific processing parameters, it should be understood that many changes and modifications can be made without departing from the invention in its broader aspects and that the procedures and processing specifics are not intended to be limiting. The illustrated procedure involves applying a transitional buffer layer on the highly porous substrate followed by at least one denser coating. In some instances, wherein the substrate is very porous with large pores, multiple coatings, which can have a graded structure of porosity or density, can be applied.

The interfacial layer typically contains, at least in part, large particles to cover the large pores of the substrate and is preferably formed with a technique that uses very viscous slurries. High-viscosity slurries tend not to flow into the pores of the anode and can accordingly facilitate a transition to the dense GDC film after forming a layer having smaller and more uniform pores relative to the substrate. Exemplary techniques for applying the interfacial buffer layer include, but are not limited to screen printing and tape casting. Once the interfacial buffer layer is formed, denser layers can be applied using other techniques and lower viscosity slurries. One example includes spin coating. Accordingly, the steps of the embodiment shown in FIG. 1 include depositing by screen printing a HV-GDC slurry followed by applying lower viscosity slurries in multiple layers.

Four different slurries were used in the embodiment shown in FIG. 1. The first slurry (Slurry #1) comprised a bimodal slurry with approximately an 80 wt %-20 wt % mixture of particles predominantly having diameters of approximately 250 nm and 5-10 nm, respectively. Slurry #1 was prepared using a GDC powder that had been sintered at 1300° C. for 2 hours and attrition milled in 2-propanol for 6 hours to achieve particle sizes of approximately 0.2 μm. GDC powder having particle sizes of 5-10 nm were added, then the slurry was attrition milled for an additional 30 min. The solid loading of this slurry was measured and then a polymer binder (B75717, FERRO CORP., Cleveland, Ohio) was added. The weight ratio of GDC to binder was 1:1. The mixture was stirred and the 2-propanol was evaporated at RT in N₂. The GDC solid loading was 50% by weight.

The second slurry (Slurry #2), which was used for spin coating, comprised a bimodal slurry with approximately an 80 wt %-20 wt % mixture of particles predominantly having diameters of approximately 250 mn and 5-10 nm, respectively. Slurry #2 was prepared using a GDC powder that had been sintered at 1300° C. for 2 hours and attrition milled in 2-propanol for 6 hours to achieve particle sizes of approximately 0.2 μm. GDC powder having particle sizes of 5-10 nm were added, then the slurry was attrition milled for an additional 30 min. The GDC was dried and mixed with water. 10% polyacrylic acid having a molecular weight of 2000 g/mol was added as an electrostatic dispersant. The pH was then adjusted to within the range of approximately 9 to approximately 10 by adding NH₃.H₂O. 10% polyvinyl alcohol and 1% Lgepal were added as a binder and a surfactant, respectively. A plasticizer and defoamer solution comprising 50% PEG and 1.6% octanol was added as a final step prior to ball milling the slurry for 16 hours.

Slurry #3, which was used for spin coating, comprised a mono-modal slurry with predominantly approximately 25 nm particles. A GDC powder having 25 nm particles was mixed with water. 10% polyacrylic acid having a molecular weight of 2000 g/mol was added as an electrostatic dispersant. The pH was then adjusted to within the range of approximately 9 to approximately 10 by adding NH₃.H₂O. 10% polyvinyl alcohol and 1% Lgepal were added as a binder and a surfactant, respectively. A plasticizer and defoamer solution comprising 50% PEG and 1.6% octanol was added as a final step prior to ball milling the slurry for 88 hours.

Slurry #4 comprised a colloidal solution for spin coating. It was prepared using a mixture comprising 10 nm 20% colloidal ceria in acetate mixed with GdNO₃ and a C₁₂EO₁₀ surfactant.

As illustrated, Slurry #1 was screen printed onto a porous substrate using a 0.5-0.7 mil screen. Exemplary substrates can include, but are not limited to Ni—YSZ and Ni-GDC. The screen-printed deposit was then sintered at 950° C. in an atmosphere containing 3% H₂, 3% H₂O, and an inert gas such as N₂, He, or Ar. Slurry #2 was subsequently spin coated at 1500 rpm and then heated to 350° C. (i.e., calcined) for an hour. The temperature ramp rate was approximately 3° C. per minute. Slurry #3 can be applied by spin coating and heated under similar conditions followed by sintering at 850° C. Optionally, multiple layers of Slurry #3 can be applied and calcined in order to build up the total thickness a desired value. Finally, Slurry #4 was applied by spin coating at 2000 rpm and sintered at 700° C. in an atmosphere containing 0.5% H₂, 3% H₂O, and balance inert gas. Alternatively, prior to spin coating Slurry #3, Slurry #4 can be applied as an infiltrant by spin coating at 2000 rpm and sintering at 750° C. Infiltrating with the finer slurry can facilitate especially dense layers of GDC.

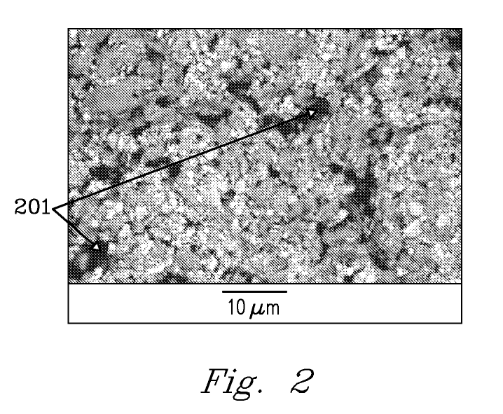

FIGS. 2-4 contain scanning electron micrographs that reveal the structure of deposits formed according to the exemplary procedure above. Referring first to FIG. 2, the micrograph shows the surface morphology of the porous substrate. Pores 201 as large as approximately 10 μm exist, which would make it difficult for traditional deposition approaches to form a dense GDC layer on the substrate.

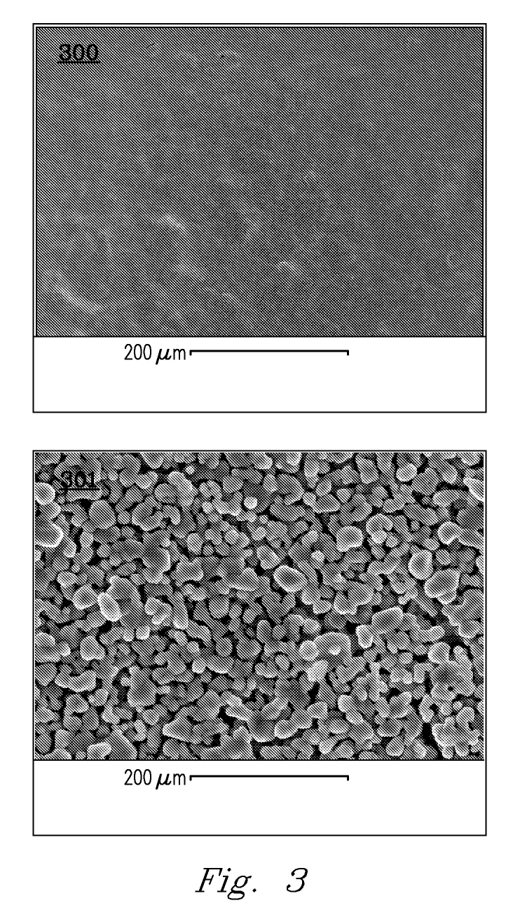

FIG. 3 shows at two different magnification levels 300, 301 the surface morphology of a sintered, screen printed GDC layer on the porous substrate. The pore sizes are much smaller and the distribution of sizes is much narrower after forming the transitional buffer layer. The dense GDC layer exhibits a uniform, crack-free surface.

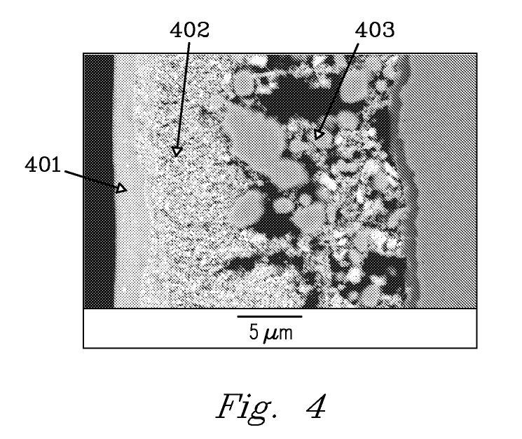

FIG. 4 is a micrograph showing a cross-section view of a dense GDC layer 401 deposited on the porous substrate 403 with the transitional buffer layer 402. The dense GDC layer 401 is approximately 2-3 μm. The transitional buffer layer 402 is approximately 4-5 μm. It should be noted that the thicknesses detailed herein are specified for illustrative purposes and are not limitations to the scope of the present invention. In fact, the thickness of the layers can be controlled by applying multiple coatings and/or multiple processing steps as well as other processing parameters.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method of fabricating a dense, Gd-doped ceria (GDC) layer on a porous substrate, the method comprising:
depositing a high-viscosity, Gd-doped ceria (HV-GDC) slurry on the porous substrate, wherein the HV-GDC slurry has a viscosity greater than 4000 cP;
sintering the HV-GDC slurry at a temperature below 1000° C. to form a transitional buffer layer that is less than 10 μm thick; and
forming the dense GDC layer on the transitional buffer layer

2. The method of claim 1, wherein said depositing comprises screen printing or tape casting the HV-GDC slurry.

3. The method of claim 1, wherein said depositing further comprises depositing a lower-viscosity, Gd-doped ceria (LV-GDC) slurry, which has a viscosity less than 4000 cP, on a HV-GDC deposit and sintering the LV-GDC slurry at a temperature below 1000° C. to form a transitional buffer layer totaling less than 10 μm thick.

4. The method of claim 3, wherein said depositing a LV-GDC slurry comprises spin coating.

5. The method of claim 3, further comprising alternating between HV-GDC and LV-GDC deposits, wherein each deposit is sintered at a temperature below 1000° C. to form a transitional buffer layer totaling less than 10 μm thick.

6. The method of claim 5, wherein the HV-GDC deposit is screen-printed or tape-casted and the LV-GDC deposit is spin-coated.

7. The method of claim 1, further comprising infiltrating the transitional buffer layer, the dense GDC layer, or both with an additional slurry comprising GDC particles that are finer than those used for the transitional buffer layer, the dense GDC layer, or both.

8. The method of claim 1, wherein the HV-GDC slurry comprises a bimodal distribution of GDC particle sizes.

9. The method of claim 8, wherein the HV-GDC slurry predominantly comprises particles having diameters of approximately 250 nm and particles having diameters of approximately 5-10 nm.

10. The method of claim 1, wherein the substrate comprises a metal or a cermet.

11. The method of claim 1, wherein the dense, GDC layer is less than or equal to approximately 5 μm thick.

12. The method of claim 10, further comprising oxidizing the metal substrate surface to minimize differences in the coefficients of thermal expansion between GDC and the metal substrate.

13. A solid-state ionic or electrochemical device comprising a dense, Gd-doped ceria (GDC) layer on a porous substrate, the device characterized by:
a transitional buffer layer, which is less than 10 μm thick and comprises GDC, located between the porous substrate and the dense GDC layer.

14. The solid-state ionic or electrochemical device of claim 13, wherein the transitional buffer layer comprises GDC particles having a bimodal distribution of particle sizes.

15. The solid-state ionic or electrochemical device of claim 13, wherein the porous substrate comprises a metal or a cermet.

16. The solid-state ionic or electrochemical device of claim 13, wherein the metal substrate surface is oxidized to have a similar coefficient of thermal expansion as GDC.

17. The solid-state ionic or electrochemical device of claim 13, wherein the porous substrate has a porosity greater than approximately 40%.

18. The solid-state ionic or electrochemical device of claim 13, wherein the porous substrate comprises pores having diameters of at least approximately 5 μm.

19. The solid-state ionic or electrochemical device of claim 13, wherein the transitional buffer layer thickness is between 2 and 5 μm.

20. The solid-state ionic or electrochemical device of claim 13, wherein the dense, GDC layer is less than or equal to approximately 5 μm thick.

21. The -state ionic or electrochemical device of claim 13, wherein the device comprises a solid-oxide fuel cell, the porous substrate comprises an anode and the dense GDC layer comprises an electrolyte.
